(19) United States
(12) Patent Application Publication
(10) Pub. No.: US 2007/0067332 A1
(43) Pub. Date: Mar. 22, 2007

(54) Distributed, secure digital file storage and retrieval

(75) Inventors: Warren Gallagher, Richmond (CA); Aaron C. Brown, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: GRIDIRON SOFTWARE, INC.

(21) Appl. No.: 11/374,046

(22) Filed: Mar. 14, 2006

Related U.S. Application Data
(60) Provisional application No. 60/661,004, filed on Mar. 14, 2005.

(51) Int. Cl. G06F 7/00

(52) U.S. Cl. 707/102

(57) ABSTRACT

A distributed file system makes use of peer resources to store file segments that can be later re-assembled to reconstitute the original file. Encryption using public keys can be employed to provide access control to a select set of users, and file deletion can be accomplished by removing the file listing, including the location of the various segments, from a table of contents. Storing each file segment on a plurality of nodes allows for redundant file storage in the event of a node being unavailable when a file is retrieved.

### CROSS REFERENCE TO RELATED APPLICATIONS

This application claims the benefit of priority of U.S. Provisional Patent Application Ser. No. 60/661,004, filed Mar. 14, 2005, which is incorporated herein by reference in its entirety.

### FIELD OF THE INVENTION

The present invention relates generally to file storage systems. More particularly, the present invention relates to a distributed file storage system with the ability to implement user access control.

### BACKGROUND OF THE INVENTION

Computer network topologies are typically divided between a hierarchical system that employs a central server with client systems that connect to it for resources, and peer-to-peer networks where a plurality of peers interact with each other to share common resources.

In a client server hierarchy, client systems typically make use of a centralized file server on which files are stored for common access. Files are typically stored on a centralized server with access control so that a selected subset of the users in the network can access the stored files. These files are typically either stored making use of a database to allow for indexing and retrieval, or are stored in a user defined directory structure. Directory structures are typically considered to be unmanaged as they are difficult to administer and provide poor searchability. A simple implementation where a single system is employed as a files server provides a single point of failure. If the hard drive of the server crashes, then the clients are unable to access files. This is typically addressed through the use of a redundant array, such as a redundant array of inexpensive drives (RAID) that employs drive mirroring, striping or a combination thereof. However, if the file server itself crashes, the clients will be denied access to all centrally stored data. This is often addressed by employing a redundant server with an identical storage array as the primary server. The two servers can their either be used in parallel to allow load balancing, with intricate synchronization systems, or the second server can be used as an active spare to allow for recovery from potential failures.

The client server architecture has its roots in mainframe systems that employed dumb terminals or thin clients that did not have sufficient local storage and had to rely upon the centralized file storage. This architecture persists to the present day despite the increasing power and storage capabilities of personal computers commonly used as client systems. The persistence of this architecture is commonly attributed to the ease of administration and not to the utilization of resources which is poor due to the fact that the now significant storage resources of client systems are not utilized.

In a typical peer to peer configuration, a plurality of systems connect to each other using a common protocol such as the ubiquitous TCP/IP protocol suite. Each system has a peer discovery routine that allows it to find the other peers in the network. Peers can employ simple access control systems by password protecting shared drives, shared directories, or shared files. Operating systems designed for such networking allow automatic mounting of other peer's shared resources during the initialization process. This allows shared resources to be viewed either as hard drives or as connected directories. Peer-to-peer setups allow for greater utilization of the resources of systems in the network. However, any system in the network can become a weak link. When files are stored on peers that are used as primary workstations, there is no guarantee of availability as workstations are often powered down and rebooted as needed by the primary user. Additionally, workstations often physically leave the network if they are mobile devices such as laptop computers. Thus, though peer-to-peer networks make better use of the resources of peers, redundancy that can provide full time accessibility of files is difficult to implement.

In both file storage topologies, file storage space is inefficiently used as multiple users receive the same file through file distribution channels including e-mail, and multiple users proceed to store the file as separate instances. This repetitive file storage is typically only addressed by having a user search for redundant files to remove them. This is both inefficient and is prone to failure and error.

Thus, it would be desirable to have a file storage network that takes advantage of the resources of the network peers while providing sufficient redundancy to preserve file access. It would be further desirable to provide a file system that prevents repetitive storage to increase file system efficiency.

### SUMMARY OF THE INVENTION

It is an object of the present invention to obviate or mitigate at least one disadvantage of previous file storage networks.

In a first aspect of the present invention, there is provided a file storage system for distributing segments of a received file to a plurality of network nodes. The file storage system comprises a file identifier, a file segmenter and a segment distributor. The generates a table of contents containing file identification information associated with the received file. The file segmenter divides the received file into a plurality of segments and modifies the generated table of contents to associate each of the plurality of segments with the file identification information. The segment distributor distributes each of the plurality of segments to at least one node in the plurality of nodes and updates the table of contents to associate at least one node in the plurality of nodes with each segment. The system may further include a table of contents database for storing the table of contents associated with the received file upon receipt from the file identifier, for receiving updates to the stored table of contents from the file segmenter and the segment distributor. Alternatively, the system may include a table of contents distributor for distributing the table of contents, as modified by the segment distributor, to at least one user associated with the plurality of network nodes.

In embodiments of the first aspect of the present invention, the file identification information includes a file size and a hash of the received file, and the file segmenter includes means to associate a hash of each segment of the received file to the table of contents associated with the received file. In other embodiments the system includes an encryption engine for encrypting each of the plurality of segments using either at least one public encryption key or a symmetric encryption key, where the encryption engine includes can also associate a public key encrypted version of the symmetric encryption key with each segment in the table of contents. The encryption engine can be integrated with the file segmenter or the segment distributor. The encryption engine can also be employed to encrypt the received file prior to dividing the file into a plurality of segments in the file segmenter.

In a second aspect of the present invention, there is provided a method of storing a file in a distributed file storage network containing a plurality of nodes. The method comprises the steps of dividing the file into a plurality of segments; distributing each of the plurality of segments to at least one node in the plurality of nodes; and creating a table of contents associated with the file containing file identification information, segment identification information and segment location information.

In embodiments of the second aspect of the present invention, the method includes the further step of encrypting the file prior to dividing the file into a plurality of segments or encrypting the file segments prior to distribution. In another embodiment, the step of creating a table of contents includes associating at least one decryption key with the table of contents. The encryption can use either public key encryption of symmetric key encryption, and the table of contents can be updated to associate at least one public key encrypted version of the symmetric encryption key with the table of contents.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a system of the present invention for distributed file storage;

FIG. 2 is a block diagram of a system of the present invention for redundant file storage in a distributed network;

FIG. 3 is a block diagram illustrating a system for receiving and distributing files according to an embodiment of the present invention; and

FIG. 4 is a flowchart illustrating a method of segmenting and tracking file distribution.

### DETAILED DESCRIPTION

Generally, the present invention provides a method and system for distributed file storage.

The present invention provides a mechanism for file storage using peer resources while addressing availability issues by providing redundancy in a distributed file system.

In a peer-to-peer network where each peer has access to file storage on other peers, files can be distributed among a plurality of nodes. However, if a peer storing a file becomes unavailable, the file itself becomes unavailable, and if the peer is compromised, so is access to the file. To address these concerns, the present invention can provide a mechanism for redundant storage and provides the ability to distribute a file as segments, so that no one peer directly has access to all segments. Thus, a file for storage can be segmented, and each of the segments can be stored on various peers in the network.

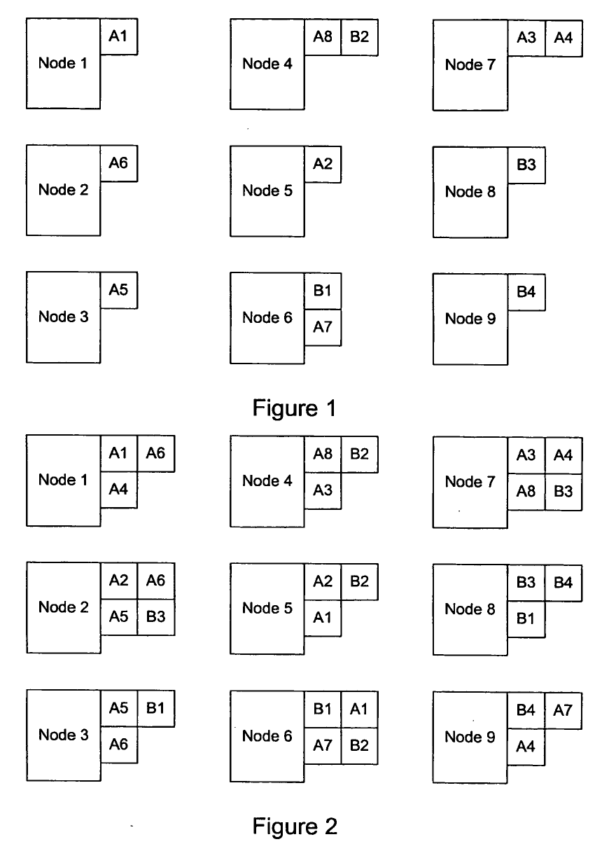

FIG. 1 illustrates an exemplary embodiment of a number of nodes in network storing a file using an embodiment of the present invention. A plurality of peers (Nodes 1-9) share file storage resources. A file, designated as File A, is stored by segmenting A into six segments, A1 through A6. Each of these segments is then stored on at least one node in the network. Similarly, File B can be segmented and stored on the nodes of the network. Selection of a node for storage can be made using any number of different techniques including a random selection from a pool of nodes. Various rules can be established, so that file segments are assigned to nodes in a round-robin fashion, file segments can be assigned so that no one node receives more than one segment, or so that nodes with a particular characterstic (e.g. high uptime ratings or large storage resources) receive segments more frequently than other nodes.

The segments are tracked by indexing them in a table of contents (TOC) associated with the stored file. By accessing the TOC, the location of the file segments can be determined. One drawback to this system is that if a single node drops out of the network, the segments that it stores become unavailable, rendering each file having a segment stored on that node incomplete. To address this, redundant segment storage is employed, as illustrated in FIG. 2. In addition to the file segmentation and scattering used in FIG. 1, each segment can be stored on multiple systems allowing for file access even when systems are removed from the network. The determination of whether a segment is stored on multiple nodes can be rule based, so that files that are not considered to be of great consequence are stored with low degrees of redundancy, while files that are considered to be crucial are stored with a high degree of redundancy. Furthermore, particular individual segments may be stored more frequency than others depending on a number of criteria including the node that the segment is stored on. In one embodiment, the number of nodes that a segment is stored upon is determined by a weighted value dependant upon the uptime of the nodes storing the segment, so that a node that had high reliability will reduce the number of nodes storing the segment, whereas storing a segment on a node that has low uptime will not contribute as much to the achievement of an overall weighted value. Thus, different strategies for how segments are distributed, and how often a segment is stored can be employed in the present invention. This results in the distribution map of segments, the number of nodes used for each file, the degree of redundancy and the size of segments can be varied in accordance with network characteristics to account for node availability.

To allow retrieval of a file, a TOC is created prior to segmentation, and the TOC is provided with file identification information. This information may be as simple as the original file size, name, and date of creation, or can include other information such as a hash of the file to allow for relatively unambiguous identification of the file. Other information including identification of the user who created the file, a file type, a user provided identifier and other such information can also be associated with the file in the TOC much as this information is stored in other database managed file systems. When a file is segmented, the segments can be identified by an original file size and a one-way hashing of the file and/or the segment. This identifying information can be stored in the TOC as an index to pair file name or descriptor with the locations of file segments, and the order that the segments must be arrange in to complete the file. The TOC preferably provides both the locations of the segments and a hash of each segment so that recovery of the segments can be easily accomplished. The original file hash can be stored along with each of the segments to provide clear disambiguation between segments. One skilled in the art will appreciate that the manner in which the TOC identifies segments can be varied without departing from the scope of the present invention.

During the recovery of a file, a user obtains the file segment locations from a TOC, contacts the nodes storing the segments, downloads and re-assembles the file. The segment identification information stored in the TOC allows the retrieval of the stored segment. If a particular node is unavailable, the segments that it stores are similarly unavailable. The user would attempt to contact the unavailable node, fail, and could then consult the TOC to find other locations of the segment. The redundant locations increased the probability of segment availability, as it requires multiple unavailable nodes to cause a segment to be unavailable.

The TOC can be provided with a list of users who have access rights to particular files, so that access to the segments can be controlled. This would restrict access at the database level. If a user is specified as having file access, an application administering the TOC can request credentials authenticating the user as an approved entity before releasing the location of the segments. Alternatively, to provide access control, a user can specify other users that should have access to the file. Then either the entire file or the segments of the file can be encrypted using public encryption keys of the users who have been granted access. Thus, the segments cannot be reassembled and used unless the requesting party holds a valid decryption key. Alternatively, other encryption techniques, including use of a symmetric key, which is then encrypted using the public keys of all users who have access to the file, can be employed as will be well understood by those skilled in the art.

To remove a file from the distributed file system, the TOC database can be altered to remove the file listing and the associated map of the segments. As access through the TOC is the sole mechanism for file retrieval, removal of the file listing from the TOC eliminates the ability for users to access the file in any meaningful way. Nodes can be configured with time-to-live values for any file that has not been accessed in a specified time frame. This allows for files to expire when they have been removed. Systems hosting a TOC can be configured to touch files in the TOC to prevent them from being deleted. In another embodiment, when the TOC database is modified to remove the TOC associated with a particular file, the TOC database can issue segment removal instructions to each node storing the segment.

To access files, the TOC database is consulted. This database can be monolithic, allowing centralized file storage information and providing a single access point to the file storage network. Alternatively, the TOC database can be distributed across a number of nodes to allow for a more distributed processing environment. In a further alternate embodiment, each node in the file storage network can store its own TOC entries in a TOC database. If the network uses multiple TOC databases, standard peer-to-peer searching techniques can be employed to find files across a number of peers.

As a further access control mechanism, when a user stores a file in the distributed file system, the TOC entry can be maintained separately from any access controlled lookup system. If the user wants to share access to the file with other users, the TOC entry can be emailed to those select users. This TOC file can be associated with the file retrieval engines at each node to allow for a local database to be built in addition to a centrally accessible database.

The distributed nature of the file storage network of the present invention allows for anonymous storage and user controlled recovery; As opposed to other peer-to-peer technologies, a user can safely and securely scatter file segments, with redundant segment storage, so that files are stored anonymously across a number of different systems. No system sees the complete file, and if encryption is used, only selected users can access the file. This allows for anonymous storage, but also enables access control. File sharing networks that allow for anonymous storage do not provide access control with anonymous submission. Furthermore, the present invention provides planned redundancy to provide for node unavailability.

The use of unambiguous file identifiers such as a hash of the file and its segments allows multiple users of a single TOC database to receive a file, such as an attachment sent to multiple users via e-mail, and to request storage of that file. If the hash of the file and its segments is used as the identifier in the TOC database, identification of a redundant file can be made by the database. The TOC database can then create a new TOC with the user-defined fields, but associate that TOC with the already stored segments. This reduces unintended redundant file storage. Because different users can assign a different file name to the same file, a file name matching cannot typically be relied upon to prevent duplication, nor can it be safely assumed that two files having the same name are actually identical. Instead, a combination of the file size, the file hash, and hashes of the segments can be used to determine if a file is already stored in the network.

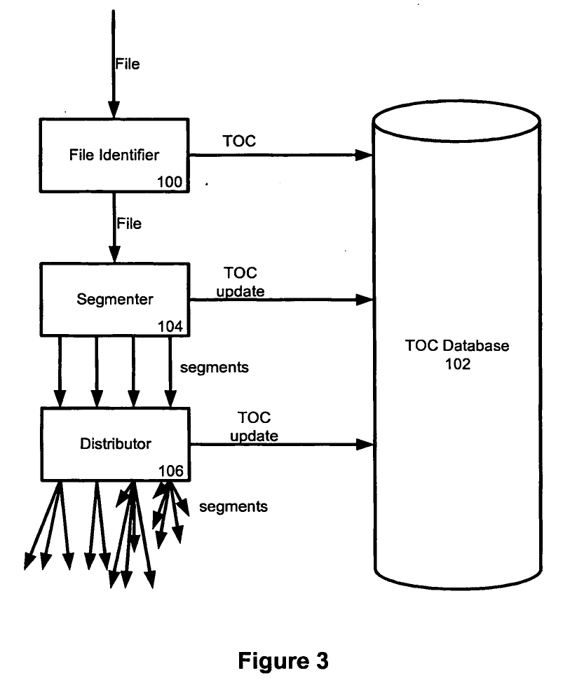

FIG. 3 illustrates an embodiment of a system of the present invention. A file is received by a file identifier 100, which creates a TOC entry in the TOC database 102. At this time, the entry would contain user-defined fields, file identifying information. The file identifying information can include the original file name, a file size and a hash of the original file.

The file is then provided to the file segmenter 104. The file segmenter 104 divides the file into a number of segments. The file segmenter 104 can divide the file into a predetermined number of segments, into segments of a predetermined size, or into segments using other such rules. Upon creating the segments, segmenter 104 updates the TOC in TOC database 102 associated with the file to provide segment identification information. The segments are then forwarded to a distributor 106, which transmits each segment to at least one storage node. The location of each segment is provided to the TOC database 102 so that the TOC associated with the file is updated. One skilled in the art will appreciate that the TOC database 102 need not be resident with the same system as the other components, and in fact each component of the above system can be executed by a different computer in a network. Furthermore, functionality of multiple elements can be combined in a single system without departing from the scope of the present invention. As noted above, various rules can be employed to determine how a file is segmented, and how the segments are distributed. The contents of the TOC must contain file identification information and segment locations, but different implementations of a system of the present invention can make use of different sets of information as discussed above.

To retrieve a file, a retrieving node would issue a database query to TOC database 102 to obtain the location of the segments. A request for a segment would then be issued to the node that stores each segment. When a node is not responsive to the request, a redundant storage node can be sent the same request if redundant storage is employed. One skilled in the art will appreciate that the order in which the nodes that store a particular segment can vary with different implementations of the present invention, and need not be in a fixed order in any implementation.

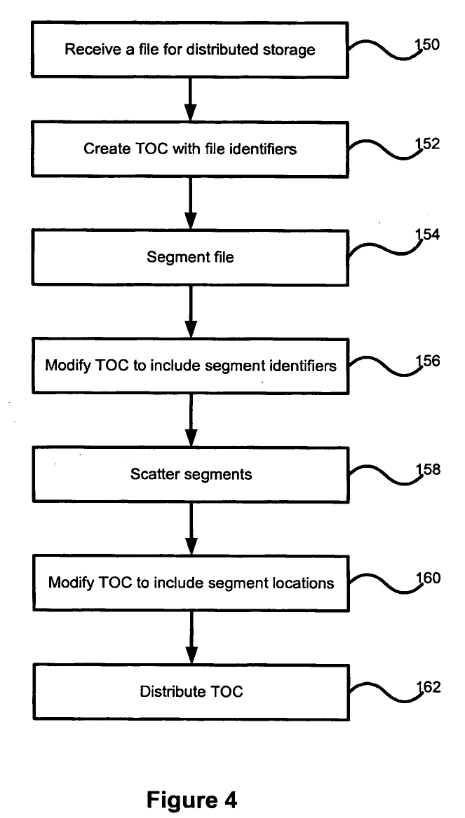

FIG. 4 is a flow chart illustrating a method of storing files according to the present invention. In step 150, a file is received for distributed file storage. A TOC entry is created for the file in step 152, and the file is then segmented in step 154. The TOC is modified to include segment identification information in step 156, and the segments are distributed or scattered in step 158. The TOC is again updated to show the segment locations in step 160. One skilled in the art will appreciate that if a single system is segmenting a file and distributing it, the creation and updates of the TOC entry can be done in a single pass. In an optional step 162, the TOC is distributed. Typically the TOC will be provided to a TOC database, but if the TOC is created as a separate file it can be sent to a number of different nodes as a mechanism for access control.

In both the above described system and method, either at the point of creating the segments or distributing them, the segments can be encrypted to provide data security. In another embodiment, the file can be encrypted upon entry to the system so that segments of an encrypted file are distributed as opposed to encrypted segments of a file.

The retrieval of large files from a distributed file system can provide performance advantages over retrieving files from a central file store, as multiple segments can be retrieved simultaneously. Each peer storing a segment can transmit the file to the requesting node in parallel, making either the requesting node or its downstream network connection the rate-limiting factor, whereas a central file server can often encounter performance problems related to its upstream bandwidth. The use of multiple peers increases the effective upstream bandwidth.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A file storage system for distributing segments of a received file to a plurality of network nodes comprising:
a file identifier for generating a table of contents containing file identification information associated with the received file;
a file segmenter for dividing the received file into a plurality of segments and for modifying the generated table of contents to associate each of the plurality of segments with the file identification information; and
a segment distributor for distributing each of the plurality of segments to at least one node in the plurality of nodes and for updating the table of contents to associate at least one node in the plurality of nodes with each segment.

2. The file storage system of claim 1, further including a table of contents database for storing the table of contents associated with the received file upon receipt from the file identifier, for receiving updates to the stored table of contents from the file segmenter and the segment distributor.

3. The file storage system of claim 1, further including a table of contents distributor for distributing the table of contents, as modified by the segment distributor, to at least one user associated with the plurality of network nodes.

4. The file storage system of claim 1, wherein the file identification information includes a file size and a hash of the received file.

5. The file storage system of claim 4, wherein the file segmenter includes means to associate a hash of each segment of the received file to the table of contents associated with the received file.

6. The file storage system of claim 1, further including an encryption engine for encrypting each of the plurality of segments.

7. The file storage system of claim 6, wherein the encryption engine includes means for encrypting each segment with at least one public encryption key.

8. The file storage system of claim 6, wherein the encryption engine includes means for encrypting each segment with a symmetric encryption key and for associating a public key encrypted version of the symmetric encryption key with each segment in the table of contents.

9. The file storage system of claim 6, wherein the encryption engine is integrated with the file segmenter.

10. The file storage system of claim 6, wherein the encryption engine is integrated with the segment distributor.

11. The file storage system of claim 1, further including an encryption engine for encrypting the received file prior to dividing the file into a plurality of segments in the file segmenter.

12. A method of storing a file in a distributed file storage network containing a plurality of nodes, the method comprising:
dividing the file into a plurality of segments;
distributing each of the plurality of segments to at least one node in the plurality of nodes; and
creating a table of contents associated with the file containing file identification information, segment identification information and segment location information.

13. The method of claim 12, further including the step of encrypting the file prior to dividing the file into a plurality of segments.

14. The method of claim 13 wherein the step of creating a table of contents includes associating at least one decryption key with the table of contents.

15. The method of claim 12 further including the step of encrypting each of the plurality of segments prior to the step of distributing.

16. The method of claim 15 wherein the step of creating a table of contents includes associating at least one decryption key with the table of contents.

17. The method of claim 15 wherein the step of encrypting includes encrypting each of the plurality of segments with at least one public encryption key.

18. The method of claim 15 wherein the step of encrypting includes encrypting each of the plurality of segments a symmetric encryption key.

19. The method of claim 18 wherein the step of creating a table of contents includes associating at least one public key encrypted version of the symmetric encryption key with the table of contents.
